(19) United States
(12) Patent Application Publication
(10) Pub. No.: US 2026/0323399 A1
(43) Pub. Date: Oct. 15, 2026

(54) COMMUNICATION METHOD, NETWORK ELEMENT, AND COMMUNICATION NODE

(71) Applicant: GUANGDONG OPPO MOBILE TELECOMMUNICATIONS CORP., LTD., Dongguan (CN)

(72) Inventor: Yang XU, Dongguan (CN)

(21) Appl. No.: 19/683,913

(22) Filed: May 21, 2026

Related U.S. Application Data
(63) Continuation of application No. PCT/CN2023/134492, filed on Nov. 27, 2023.

(51) Int. Cl. H04W 28/18; H04W 28/02; H04W 28/08

(52) U.S. Cl. CPC H04W 28/18; H04W 28/0226; H04W 28/0925

(57) ABSTRACT

A communication method includes the following. A first network element generates a first-part parameter corresponding to a terminal based on input information. The first-part parameter corresponding to the terminal includes at least one of a first-part context parameter of the terminal or a first-part policy of the terminal. The first network element sends a response message to one or more nodes. The response message carries at least part of the first-part parameter corresponding to the terminal, and the one or more nodes includes at least one of the terminal, an access network device corresponding to the terminal, or one or more core network elements.

### CROSS-REFERENCE TO RELATED APPLICATION(S)

This application is a continuation of International Application No. PCT/CN2023/134492, filed Nov. 27, 2023, the entire disclosure of which is incorporated herein by reference.

### TECHNICAL FIELD

This disclosure relates to the field of communication, in particular to a communication method, a network element, and a communication node.

### BACKGROUND

Currently, each interaction procedure needs to be defined in the 3rd Generation Partnership Project (3GPP) system. Specifically, in a relevant procedure involving the generation of context and/or a policy of a terminal, according to the definition of the relevant procedure, multiple nodes are required to perform collaboration and interaction to generate the context and/or the policy of the terminal corresponding to each node. It can be seen that the aforementioned relevant procedure has the problem of being unable to flexibly allocate to each node the corresponding context parameter of the terminal and/or the policy of the terminal.

### SUMMARY

In a first aspect, a communication method is provided. The method includes the following. A first network element generates a first-part parameter corresponding to a terminal based on input information. The first-part parameter corresponding to the terminal includes at least one of a first-part context parameter of the terminal or a first-part policy of the terminal. The first network element sends a response message to one or more nodes. The response message carries at least part of the first-part parameter corresponding to the terminal, and the one or more nodes includes at least one of the terminal, an access network device corresponding to the terminal, or one or more core network elements.

In a second aspect, a network element is provided. The network element includes a transceiver, a processor, and a memory. The memory is configured to store a computer program. The transceiver is configured to communicate with other devices. The processor is configured to invoke and execute the computer program stored in the memory to cause the first network element to perform the aforementioned method.

In a third aspect, a communication node is provided. The communication node includes a transceiver, a processor, and a memory. The memory is configured to store a computer program. The transceiver is configured to communicate with other devices. The processor is configured to invoke and execute the computer program stored in the memory to cause the communication node to receive a response message sent by a first network element. The response message carries at least part of a first-part parameter corresponding to a terminal, and the first-part parameter corresponding to the terminal includes at least one of a first-part context parameter of the terminal or a first-part policy of the terminal.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1 is a schematic diagram of an application scenario according to embodiments of the present disclosure.

FIG. 2 is a schematic diagram of an architecture of a 5th-Generation (5G) network system.

FIG. 3 is a schematic flowchart of a communication method according to an embodiment of the present disclosure.

FIG. 4 is a schematic flowchart of a communication method according to another embodiment of the present disclosure.

FIG. 5 is a schematic diagram of a scenario for a training process of a large model according to an embodiment of the present disclosure.

FIG. 6 is a schematic diagram of a processing scenario for a large model node according to an embodiment of the present disclosure.

FIG. 7 is a schematic diagram of a system composition structure including a large model node according to an embodiment of the present disclosure.

FIG. 8 is a schematic flowchart of a communication method according to another embodiment of the present disclosure.

FIG. 9 is a schematic diagram of another system composition structure including a large model node according to an embodiment of the present disclosure.

FIG. 10 is a schematic block diagram of a first network element according to an embodiment of the present disclosure.

FIG. 11 is a schematic block diagram of a target node according to an embodiment of the present disclosure.

FIG. 12 is a schematic block diagram of a communication device according to embodiments of the present disclosure.

FIG. 13 is a schematic block diagram of a chip according to embodiments of the present disclosure.

FIG. 14 is a schematic block diagram of a communication system according to embodiments of the present disclosure.

### DETAILED DESCRIPTION

The following will describe technical solutions of embodiments of the disclosure with reference to the accompanying drawings in embodiments of the disclosure.

The technical solutions in embodiments of the disclosure are applicable to various communication systems, for example, a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi), a 5^{th} generation (5G) system, or other communication systems.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, vehicle to everything (V2X) communication, etc. Embodiments of the disclosure can also be applied to these communication systems.

In an embodiment, a communication system in embodiments of the disclosure may be applied to a carrier aggregation (CA) scenario, a dual connectivity (DC) scenario, or a standalone (SA) network deployment scenario.

In an embodiment, the communication system in implementations of the disclosure is applicable to an unlicensed spectrum, and an unlicensed spectrum may be regarded as a shared spectrum. Or the communication system in embodiments of the disclosure is applicable to a licensed spectrum, and a licensed spectrum may be regarded as a non-shared spectrum.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, a user device, etc. The terminal device may be a station (ST) in a WLAN, a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, and a terminal device in a next-generation communication system, for example, a terminal device in an NR network, a terminal device in a future evolved public land mobile network (PLMN), etc.

In embodiments of the disclosure, the terminal device can be deployed on land, which includes indoor or outdoor, handheld, wearable, or in-vehicle. The terminal device can also be deployed on water (such as ships, etc.). The terminal device can also be deployed in the air (such as airplanes, balloons, satellites, etc.).

In embodiments of the disclosure, the terminal device can be a mobile phone, a pad, a computer with wireless transceiver functions, a virtual reality (VR) terminal device, an augmented reality (AR) terminal device, a wireless terminal device in industrial control, a wireless terminal device in self-driving, a wireless terminal device in remote medicine, a wireless terminal device in smart grid, a wireless terminal device in transportation safety, a wireless terminal device in smart city, a wireless terminal device in smart home, etc.

By way of explanation rather than limitation, in embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in a WLAN, a base transceiver station (BTS) in GSM or CDMA, may also be a Node B (NB) in WCDMA, and may also be an evolutional Node B (eNB or eNodeB) in LTE, or a relay station or AP, or an in-vehicle device, a wearable device, a network device (gNB) in an NR network, a network device in a future evolved PLMN, a network device in an NTN, etc.

By way of explanation rather than limitation, in embodiments of the disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In embodiments of the disclosure, the network device provides services for a cell, and the terminal device communicates with the network device on a transmission resource (for example, a frequency-domain resource or a spectrum resource) for the cell. The cell may be a cell corresponding to the network device (for example, a base station). The cell may correspond to a macro base station, or may correspond to a base station corresponding to a small cell. The small cell may include: a metro cell, a micro cell, a pico cell, a femto cell, and the like. These small cells are characterized by small coverage and low transmission power and are adapted to provide data transmission service with high-rate.

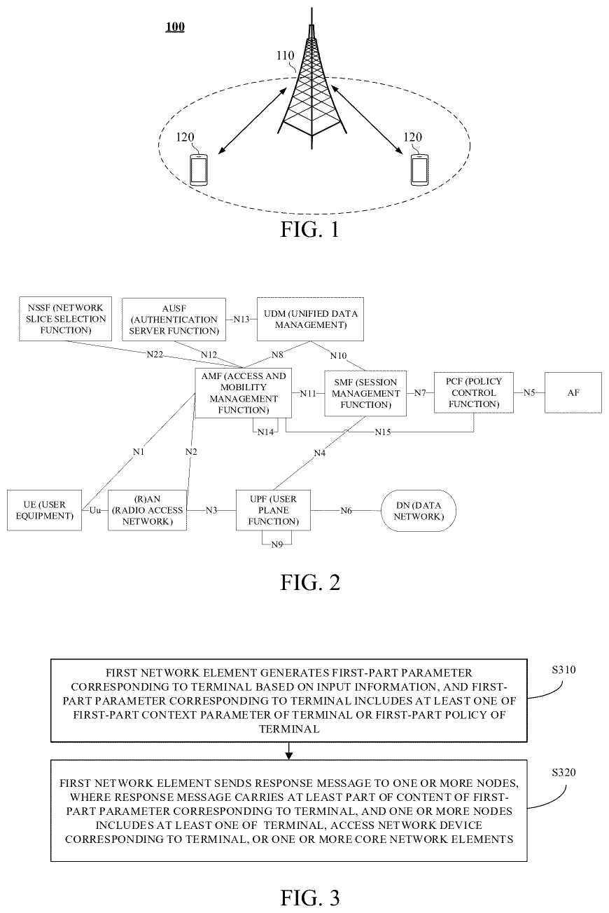

FIG. 1 exemplarily illustrates a communication system 100. The communication system includes one network device 110 and two terminal devices 120. In a possible implementation, the communication system 100 may include multiple network devices 110, and the coverage area of each network device 110 may include other numbers of terminal devices 120. Embodiments of the disclosure are not limited in this regard.

In a possible implementation, the communication system 100 may further include other network entities such as a mobility management entity (MME) and an access and mobility management function (AMF). Embodiments of the disclosure are not limited in this regard. The network device may include an access-network device and a core-network device, that is, the wireless communication system further includes multiple core-networks for communicating with the access-network device. The access-network device may be an evolutional node B (eNB or e-NodeB), a macro base station, a micro base station (also referred to as a “small base station”), a pico base station, an access point (AP), a transmission point (TP), or a new generation Node B (gNodeB) in a long-term evolution (LTE) system, a next radio (NR) system, an authorized auxiliary access long-term evolution (LAA-LTE) system, etc.

It should be understood that, a device with communication functions in a network or system in embodiments of the disclosure may be referred to as a communication device. For example, as illustrated in FIG. 1, the communication device may include a network device and a terminal device with communication functions. The network device and the terminal device may be the specific devices in embodiments of the disclosure, which will not be repeated herein. The communication device may further include other devices in the communication system, such as a network controller, a mobility management entity, or other network entities. Embodiments of the disclosure are not limited in this regard.

For ease of understanding of embodiments of the disclosure, the following briefly describes the basic processes and basic concepts involved in embodiments of the disclosure. It should be understood that the basic processes and basic concepts described below do not limit embodiments of the disclosure.

FIG. 2 is a schematic diagram of an architecture of a 5th-Generation (5G) network system, which includes the following components. A network slice selection function (NSSF) is mainly used for managing network slice-related information, such as selecting a network slice for a terminal device. An authentication server function (AUSF) is used for completing identity authentication for user access. A unified data management (UDM) is used for managing and storing subscription data and authentication data. An access and mobility management function (AMF) is used for completing mobility management, security anchor, user equipment (UE) security policy management, etc. In addition to performing mobility management for the UE, the AMF is also responsible for forwarding session management-related message between the UE and a session management function (SMF). The SMF is used for completing session management, UE IP address allocation and management, etc. A policy control function (PCF) is responsible for formulating policies related to UE mobility management, session management, and charging, etc. An application function (AF) is used for an external application server. A user plane function (UPF) is used for complex user plane processing, such as forwarding traffic between an radio access network (RAN) and the Internet, reporting traffic usage, and implementing a Quality of service (QoS) policy. A data network (DN) refers to an external data network of a 5G core network (5GC) (such as the Internet). Data transmission is performed through corresponding interfaces between nodes in the 5GC, between the UE and the nodes in the 5GC, between the UE and the (R)AN, and between the RAN and the nodes in the 5GC. For example, as illustrated in FIG. 2, the data transmission is performed between the AMF and the NSSF in the 5GC through interface N22. The data transmission is performed between the AMF and the SMF through interface N11. The data transmission is performed between the AMF and the AUSF through interface N12. The data transmission is performed between the AMF and the UDM through interface N8. The data transmission is performed between the SMF and UPF through interface N4. The data transmission is performed between the UPF and the external data network through interface N6, and the data transmission is performed between the UPF and the AN through interface N3. The UE establishes an access-stratum connection with the (R)AN through interface Uu to interact access-stratum messages and transmit wireless data. The UE establishes a non-access-stratum (NAS) connection with the AMF through interface N1 to interact NAS messages. The data transmission is performed between the RAN and the AMF through interface N2, and the data transmission is performed between the RAN and UPF through interface N3.

It should be understood that only some interfaces between nodes are described above, and other interfaces between other nodes in the 5GC illustrated in FIG. 2 are not elaborated one by one. In FIG. 2, in addition to the UE, the (R)AN, and the DN, other nodes are all core network nodes. The core network nodes can be further divided into user plane nodes (i.e., the UPF in FIG. 2) and control plane nodes (nodes other than the UPF among the core network nodes).

In current standards, corresponding context, policies, etc. are generated (and/or used) by interaction between the network elements in the 5G system, and relevant 5G procedures include at least part of the following: a registration procedure, a registration update procedure, a protocol data unit (PDU) session establishment procedure, a PDU session modification procedure, a UE update configuration (UCU) procedure, a service request procedure, a paging procedure, etc. In the above procedures, the UE context and policies generated and/or used by interaction between the network elements in the 5G system include but are not limited to at least one of the following: a UE context parameter (set) in the AMF, a UE context parameter (set) in the SMF, or a UE policy. The UE context parameter (set) in the AMF includes but is not limited to at least one of the following: an access frequency point parameter set, a paging cycle configuration parameter set, a mobility restriction parameter set, a location parameter set, an access management policy association parameter set, a network slice configuration parameter set, or a configuration parameter set for each PDU session. The UE context parameter (set) in the SMF includes but is not limited to at least one of the following: a PDU session attribute parameter set (single network slice selection assistance information (S-NSSAI), data network name (DNN), session and service continuity (SSC) mode, etc.)), an application server interaction parameter set (IP address, DN access identifier (DNAI), etc.), a descriptor and binding parameter set for each data flow, or a QoS parameter set for each data flow. The UE Policy includes but is not limited to at least one of the following: a UE route selection policy (URSP) rule list (target descriptor (TD)+route selection descriptor (RSD)), an access network discovery and selection policy (ANDSP) rule list (WLAN selection policy (WLANSP)), or an access traffic steering, switching, splitting (ATSSS) policy rule list.

The current 3rd Generation Partnership Project (3GPP) 5G system uses a service based architecture (SBA) bus architecture. The SBA bus architecture is implemented based on a service based interface (SBI) interface (23501). However, each interaction procedure (23502) still needs to be defined, which results in an enormous protocol workload, and different interactions are still restricted by artificially defined procedure limitations, making it impossible for each node to achieve truly flexible interaction. For example, in the relevant procedures for negotiating and generating context and/or policies of the terminal, messages sent by the RAN must pass through the AMF to reach the SMF, and messages sent by the PCF must pass through the SMF to be sent to the UPF. The essential purpose of formulating the above relevant procedures is to negotiate and generate context and/or policies of the terminal, but the process requires collaboration and interaction between various nodes, making it impossible for each node to achieve truly flexible interaction. In addition, each node involved in the above relevant procedures has limitations. For example, each node is restricted by the relevant parameters that the node can obtain, so the final generated context and/or policies of the terminal corresponding to each node may not be the most suitable or optimal.

It should be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

It should be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that that there is an association relationship between A and B.

In the elaboration of embodiments of the disclosure, the term “correspondence” may mean that there is a direct or indirect correspondence between the two, may mean that there is an association between the two, or may mean a relationship of indicating and indicated, configuring and configured, etc.

In order for better understanding of technical solutions of embodiments of the disclosure, technologies related to the embodiments of the disclosure will be elaborated below. The following related art as an optional scheme can be arbitrarily combined with the technical solutions of embodiments of the disclosure, which shall all belong to the protection scope of embodiments of the disclosure.

FIG. 3 is a schematic flowchart of a communication method according to an embodiment of the present disclosure. The method includes at least part of the following content.

S310, a first network element generates a first-part parameter corresponding to a terminal based on input information. The first-part parameter corresponding to the terminal includes at least one of a first-part context parameter of the terminal or a first-part policy of the terminal.

S320, the first network element sends a response message to one or more nodes. The response message carries at least part of the first-part parameter corresponding to the terminal, and the one or more nodes includes at least one of the following: the terminal, an access network device corresponding to the terminal, or one or more core network elements. The at least part of the first-part parameter corresponding to the terminal may include at least one of the first-part context parameter of the terminal or the first-part policy of the terminal.

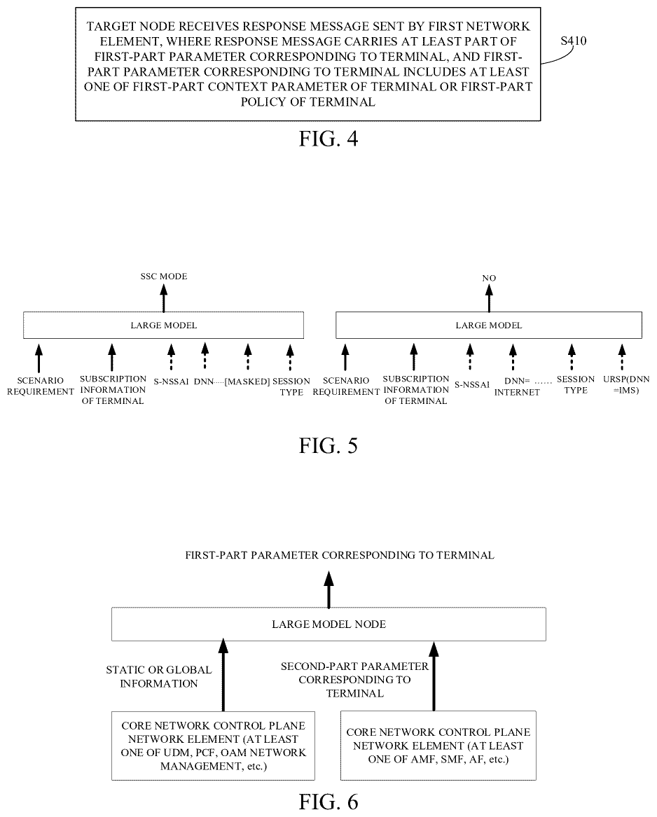

FIG. 4 is a schematic flowchart of a communication method according to another embodiment of the present disclosure. The method includes at least part of the following content.

S410, a target node receives a response message sent by a first network element. The response message carries at least part of a first-part parameter corresponding to a terminal, and the first-part parameter corresponding to the terminal includes at least one of a first-part context parameter of the terminal or a first-part policy of the terminal.

The first network element may have computing capability and/or processing capability, and the first network element may perform information transmission with each of the one or more nodes.

The terminal may be a 3GPP terminal, that is, a terminal capable of accessing a 3GPP network to send and receive data. Exemplarily, the terminal may be a mobile phone, a watch, a tablet, etc. Various possible types of the terminal are not enumerated or limited in embodiments of the disclosure.

The access network device corresponding to the terminal is an access network device serving the terminal.

The one or more core network elements may include at least one of the following: one or more core network control plane network elements or one or more core network user plane network elements. The one or more core network control plane network elements may include at least one of the following: a network element responsible for access and/or mobility management, or a network element responsible for session management. It should be noted that each network element in the present embodiment may alternatively be referred to as a node. For example, a core network control plane network element may alternatively be referred to as a core network control plane node, and no repeated explanation will be provided below.

In some possible examples, the 3GPP system follows the division of network elements in the 5G architecture. In such examples, the network element responsible for access and/or mobility management may include the AMF. The network element responsible for session management may include the SMF. The one or more core network user plane network elements may include one or more UPF.

It should be understood that, in addition to at least one of the network element responsible for access and/or mobility management or the network element responsible for session management, the one or more core network control plane network elements may further include at least one of the following: the PCF, the UDM, a user data repository (UDR), an application function (AF), operations, administration and maintenance (OAM), etc. The network elements that the core network control plane network element may include are not enumerated or limited in embodiments of the disclosure.

In some possible examples, the 3GPP system does not follow the division of network elements in the 5G architecture. In such examples, the one or more core network elements may be divided on demand. The specific manner of dividing the core network elements, or the names or types of the divided core network elements are not enumerated or limited in embodiments of the disclosure.

In some possible implementations, the input information may include a request message.

Before the first network element generates the first-part parameter corresponding to the terminal based on the input information, the first network element further receives the request message sent by the target node. The target node is one of the terminal and a second network element, where the second network element is one of the one or more core network elements.

Correspondingly, before the target node receives the response message sent by the first network element, the target node further sends the request message to the first network element, where the request message is used for the first network element to generate the first-part parameter corresponding to the terminal.

In an embodiment, the target node is the terminal. The processing before the terminal receives the response message sent by the first network element may include that the terminal sends the request message to the first network element. The first network element may receive the request message sent by the target node as follows. The first network element receives the request message sent by the terminal.

The request message may be a NAS message. Exemplarily, the request message may be a request message included in at least one of the following procedures: a registration procedure, a registration update procedure, a PDU session establishment procedure, or a PDU session modification procedure. Specifically, the request message may be at least one of the following: a registration request message, a registration update message, a PDU session establishment request message, or a PDU session modification request message.

Optionally, when the first network element supports an NAS protocol, the terminal may send the request message to the first network element as follows. The terminal sends the request message to the first network element through the access network device. Correspondingly, the first network element receives the request message sent by the terminal as follows. The first network element receives the request message sent by the terminal through the access network device.

Optionally, when the first network element does not support the NAS protocol, the terminal may send the request message to the first network element as follows. The terminal sends the request message to a third network element through the access network device, and the request message is sent (or forwarded) to the first network element by the third network element. Correspondingly, the first network element receives the request message sent by the terminal as follows. The first network element receives the request message sent by the terminal through the third network element, where the third network element receives the request message sent by the terminal through the access network device. The third network element is a core network control plane network element supporting the NAS protocol, such as the AMF.

In an embodiment, the target node is the second network element. The processing before the second network element receives the response message sent by the first network element may include that the second network element sends the request message to the first network element. The first network element may receive the request message sent by the target node as follows. The first network element receives the request message sent by the second network element.

The request message may be sent (or triggered, or generated) in at least one of the following procedures: the registration procedure, the registration update procedure, the PDU session establishment procedure, or the PDU session modification procedure.

The second network element and the third network element may be the same or different, which is not limited herein.

The request message may carry at least one of the following: an identifier of the terminal, scenario information, or user preference information.

The identifier of the terminal may include but is not limited to at least one of the following: a subscription permanent identifier (SUPI) of the terminal, a subscription concealed identifier (SUCI) of the terminal, a permanent equipment identifier (PEI) of the terminal, a 5G globally unique temporary identifier (5G-GUTI) of the terminal, an internal-group identifier (IGI) of the terminal, a generic public subscription identifier (GPSI) of the terminal, etc.

The scenario information may be used for indicating at least one of the following scenario types: connection, computation, data, model, etc. The scenario information may alternatively be referred to as scenario requirement.

The user preference information may be preference-related information set by a user of the terminal according to actual needs. The user preference information may alternatively be referred to as user preference setting, or user preference information of the terminal, or user preference setting of the terminal, user preferred setting of the terminal, etc. Exemplarily, the user preference information may be preferences and/or parameter values related to the first-part parameter corresponding to the terminal set by the user of the terminal. For example, the user preference information may be specific parameter types and/or specific parameter names and/or parameter values, set by the user of the terminal, that are included in the first-part parameter corresponding to the terminal. For another example, the user preference information may be other parameters and/or other parameter values and/or other information, set by the user of the terminal, that need to be obtained or used when generating the first-part parameter corresponding to the terminal. It should be understood that the above is only an exemplary description of the user preference information, the possible content, setting manner, etc. of the user preference information are not limited or enumerated in embodiments of the disclosure.

In some possible implementations, the input information may include static or global information. The static or global information may include at least one of: subscription information of the terminal, a policy and charging control (PCC) rule of the terminal, network status information, the scenario information, or the user preference information. That is, the input information may include at least one of: the subscription information of the terminal, the PCC rules of the terminal, the network status information, the scenario information, or the user preference information.

The static or global information may also be referred to as static information, global information, default information, etc. The possible names of the static or global information are not limited or enumerated in embodiments of the disclosure. For brevity, the static or global information may be used for relevant descriptions below, that is, the static or global information involved below includes at least one of the subscription information of the terminal, the PCC rule of the terminal, the network status information, the scenario information, or the user preference information, and no repeated explanation will be provided below.

Before generating the first-part parameter corresponding to the terminal based on the input information, the first network element needs to obtain the static or global information from at least part of the one or more core network elements. Specifically, before generating the first-part parameter corresponding to the terminal based on the input information, the first network element further obtains from at least part of the one or more core network elements at least one of the following: the subscription information of the terminal, the PCC rule of the terminal, the network status information, the scenario information, or the user preference information.

Optionally, the first network element may obtain the static or global information from at least part of the one or more core network elements, in the case that the request message sent by the target node is received.

Optionally, the first network element may obtain the static or global information from at least part of the one or more core network elements, in the case that the request message sent by the target node is not received and the need to generate the first-part parameter corresponding to the terminal is triggered or determined according to other configurations. Other configurations herein may be set according to actual conditions, which are not limited in the present embodiment.

The parameters and/or content that the subscription information of the terminal may include may be the same as the parameters and/or content specified in relevant protocols, which are not limited in the present embodiment. The parameters and/or content that the PCC rule of the terminal may include may be the same as the parameters and/or content specified in relevant protocols, which are not limited in the present embodiment.

The network status information may include at least one of the following: the usage of computing resources at the network side, the usage of storage resources at the network side, the usage of communication resources at the network side, the transmission rate at the network side, the proportion of the maximum upper-limit rate at the network side, the network congestion status, etc. The network side may refer to at least one of the following: the entire network side, the core network side, any one or more network elements at the network side, etc.

At least one of the subscription information of the terminal, the PCC rule of the terminal, the network status information, the scenario information, or the user preference information may be separately stored in at least part of the one or more core network elements.

In an embodiment, the 3GPP system follows the division of network elements in the 5G architecture, and the at least part of the one or more core network elements may include at least one of the UDM, the UDR, the PCF, the OAM, etc.

At least one of the subscription information of the terminal, the PCC rule of the terminal, the network status information, the scenario information, or the user preference information may be stored in at least one of the UDM, the UDR, the PCF, or the OAM. For example, the subscription information of the terminal may be stored in the UDM/UDR. The PCC rule of the terminal may be stored in the PCF. The network status information, the scenario information, and the user preference information may be stored in at least one of the following: the UDM, the UDR, the PCF, the OAM, etc. Correspondingly, the first network element may obtain the subscription information of the terminal from the UDM/UDR, obtain the PCC rule of the terminal from the PCF, and obtain at least one of the network status information, the scenario information, or the user preference information from at least one of the UDM, the UDR, the PCF, or the OAM.

It should be understood that the above is only an exemplary description of the at least part of core network elements and the content stored therein. In actual processing, the subscription information of the terminal, the PCC rule of the terminal, the network status information, the scenario information, and the user preference information may be stored in but not limited to the above storage manners. Also, the manner in which the first network element obtains at least one of the subscription information of the terminal, the PCC rule of the terminal, the network status information, the scenario information, and the user preference information is not limited to the above examples. Embodiments of the disclosure are not limited in this regard.

In an embodiment, the 3GPP system does not follow the division of network elements in the 5G architecture, the one or more core network elements may be divided on demand, and each of the subscription information of the terminal, the PCC rule of the terminal, the network status information, the scenario information, and the user preference information may be stored in at least part of core network elements of the one or more core network elements according to actual needs. The content that may be stored in different core network elements among the at least part of core network elements is not limited in embodiments of the disclosure. Similarly, the specific manner in which the first network element obtains at least one of the subscription information of the terminal, the PCC rule of the terminal, the network status information, the scenario information, or the user preference information from at least part of core network elements of the one or more core network elements is not limited or enumerated.

In some possible implementations, the first-part parameter corresponding to the terminal may refer to at least part of information or at least part of parameters at a terminal granularity that are dynamic.

It should be noted that the first-part parameter corresponding to the terminal refers to the at least part of information or at least part of parameters at the terminal granularity that are dynamic and need to be generated by the first network element this time, or generated or obtained after the first network element performs processing. Specifically, the at least part of information or at least part of dynamic parameters at the terminal granularity that are dynamic may refer to at least part of information or at least part of parameters that are generated by the first network element for the terminal each time the terminal accesses the network (such as registration), or when the terminal initiates network connection establishment (such as initiating session establishment), or when a condition changes (such as the terminal undergoes location update). When the first network element dynamically generates the at least part of information or at least part of parameters for the terminal, the at least part of information/parameters are related to the location of the terminal, the real-time status of the network, user preferences, terminal capability, service executed by the terminal, etc. Therefore, even if the static or global information is the same, the parameters and/or parameter values generated may be different at different times when the first network element generates the at least part of information or at least part of parameters at the terminal granularity that are dynamic.

The first-part context parameter of the terminal may include at least one of the following: at least part of context parameters of the terminal used by each core network element among at least part of core network elements of the one or more core network elements, at least part of context parameters used by the terminal, or at least part of context parameters of the terminal used by the access network device.

The first-part policy of the terminal may include at least part of the policies of the terminal.

In an embodiment, the first-part parameter corresponding to the terminal may be all parameters corresponding to the terminal. In the present embodiment, the input information may not include a second-part parameter corresponding to the terminal.

Specifically, the first-part context parameter of the terminal may include at least one of the following: all context parameters of the terminal used by each core network element among at least part of core network elements of the one or more core network elements, all context parameters used by the terminal, or all context parameters of the terminal used by the access network device. In the embodiment, the access network device is an access network device corresponding to the terminal.

The first-part policy of the terminal may include all policies corresponding to the terminal specified in relevant protocols. The policies include at least one of the following: a UE policy, a packet detection rule (PDR) policy, or a data flow binding policy.

In an embodiment, the first-part parameter corresponding to the terminal may be part of the parameters corresponding to the terminal. In the present embodiment, the input information may include the second-part parameter corresponding to the terminal, where the second-part parameter corresponding to the terminal is at least partially different from the first-part parameter corresponding to the terminal.

The second-part parameter corresponding to the terminal may refer to the dynamic information or parameters that have been generated at the terminal granularity. It should be noted that the second-part parameter corresponding to the terminal refers to the dynamic information or parameters at the terminal granularity that have been generated by the network side (such as one or more network elements other than the first network element at the network side) in the current procedure. Specifically, the dynamic information or parameters that have been generated at the terminal granularity may refer to: information or parameters generated or updated by the network side (such as one or more network elements other than the first network element at the network side) for the terminal each time the terminal accesses the network (such as registration), or when the terminal initiates network connection establishment (such as initiating session establishment), or when a condition changes (such as the terminal undergoes location update). When the network side (such as one or more network elements other than the first network element at the network side) dynamically generates or updates the part of information or parameters for the terminal, the dynamic generated information or parameters are related to the location of the terminal, the real-time status of the network, the user preferences, the terminal capability, the service executed by the terminal, etc. Therefore, even if the static or global information is the same, the parameters and/or parameter values generated or updated may be different at different times the network side (such as one or more network elements other than the first network element at the network side) generates or updates the dynamic information or parameters at the terminal granularity.

That is, part of all parameters corresponding to the terminal are parameters that have been generated or configured by one or more network elements other than the first network element at the network side, and this part of parameters are the second-part parameter corresponding to the terminal. At least part of all parameters corresponding to the terminal are parameters currently generated by the first network element, and this part of parameters are the first-part parameter corresponding to the terminal. The second-part parameter corresponding to the terminal is used as input information of the first network element to enable the first network element to output the first-part parameter corresponding to the terminal.

Optionally, the second-part parameter corresponding to the terminal and the first-part parameter corresponding to the terminal may be completely different.

Optionally, the second-part parameter corresponding to the terminal and the first-part parameter corresponding to the terminal may be partially the same (or partially overlapping). For example, the second-part parameter corresponding to the terminal may include one or more parameter with the same names as that in the first-part parameter corresponding to the terminal. For parameters with the same name in the first-part parameter and the second-part parameter corresponding to the terminal, the corresponding parameter values may be the same or different. In this case, after generating the first-part parameter corresponding to the terminal, the first network element uses the first-part parameter corresponding to the terminal to cover or at least partially cover the second-part parameter corresponding to the terminal. For example, for a parameter with the same name in both the first-part parameter and the second-part parameter corresponding to the terminal, a parameter value in the second-part parameter may be replaced with a corresponding parameter value in the first-part parameter. Correspondingly, after the first-part parameter corresponding to the terminal is sent to each of the one or more nodes by the first network element, if one or more parameters generated locally by any one node have the same parameter names as one or more parameters in the first-part parameter corresponding to the terminal, the node will also use the parameter values corresponding to the same parameter names in the first-part parameter corresponding to the terminal to cover or replace the parameter values corresponding to the local parameter names.

For example, assuming that the second-part parameter corresponding to the terminal includes parameter 1 (the value of parameter 1 is a1) and parameter 2 (the value of parameter 2 is a2), and the first-part parameter corresponding to the terminal generated by the first network element includes parameter 1 (the value of parameter 1 is b1), parameter 3 (the value of parameter 3is b3), and parameter 4 (the value of parameter 4 is b4), then the two parts of parameters have the same parameter 1, and the value of parameter 1 in the first-part parameter is different from the value of parameter 1 in the second-part parameter. In this case, the value of parameter 1 in the second-part parameter is replaced with the value b1 of parameter 1 in the first-part parameter.

Specifically, the first-part context parameter of the terminal may include at least one of the following: part of context parameters of the terminal used by each of at least part of the one or more core network elements, part of context parameters used by the terminal, part of context parameters of the terminal used by the access network device.

The first-part policy of the terminal may include part of the policies of the terminal.

The second-part parameter corresponding to the terminal may include at least one of a second-part context parameter of the terminal or a second-part policy of the terminal. The second-part context parameter of the terminal is at least partially different from the first-part context parameter of the terminal, and the second-part policy of the terminal is at least partially different from the first-part policy of the terminal.

Specifically, the second-part context parameter of the terminal may include at least one of the following: a context parameter that has been generated or configured among all context parameters of the terminal used by each of at least part of the one or more core network elements, a context parameter that has been generated or configured among all context parameters of the terminal, or a context parameter that has been generated or configured among all context parameters of the terminal used by the access network device.

The second-part policy of the terminal may include a policy that has been generated or configured among all policies corresponding to the terminal.

Before the first network element generates the first-part parameter corresponding to the terminal based on the input information, the first network element further obtains the second-part parameter corresponding to the terminal from at least part of the one or more core network elements.

The first network element may obtain the second-part parameter corresponding to the terminal from at least part of the one or more core network elements as follows. From each core network element among the at least part of the one or more core network elements, the first network element obtains part of parameters corresponding to the terminal that has been generated by the core network element, and takes the part of parameters corresponding to the terminal that has been generated by the core network element as the second-part parameter corresponding to the terminal. It should be noted that the part of parameters corresponding to the terminal that have been generated or configured by different core network elements among the at least part of core network elements may be different. The part of parameters corresponding to the terminal that have been generated or configured by each core network element may include at least part of parameters in the second-part context parameter of the terminal and/or at least part of policies in the second-part policy of the terminal.

For example, the at least part of core network elements of the one or more core network elements may include the AMF and the SMF. The AMF has generated or configured one or more context parameters of the terminal, and the SMF has generated or configured one or more context parameters of the terminal. The first network element may obtain from the AMF one or more context parameters of the terminal that have been generated or configured by the AMF, and obtain from the SMF the one or more context parameters of the terminal that have been generated or configured by the SMF. The first network element takes the one or more context parameters of the terminal that have been generated or configured by the AMF and the one or more context parameters of the terminal that have been generated or configured by the SMF as the second-part parameter corresponding to the terminal.

Optionally, the first network element may obtain the second-part parameter corresponding to the terminal from at least part of core network elements of the one or more core network elements, in the case that the request message sent by the target node is received.

If the target node is the second network element, and the second network element is one of the at least part of the one or more core network elements, the request message sent by the second network element may carry the same content as the content in the foregoing embodiment. In this case, the processing of the first network element obtaining the second-part parameter corresponding to the terminal from the at least part of the one or more core network elements is the same as the processing in the foregoing embodiment, and no repeated explanation will be provided.

If the target node is the second network element, and the second network element is one of the at least part of the one or more core network elements, the request message sent by the second network element may further carry part of parameters corresponding to the terminal that have been generated or configured by the second network element. The part of parameters corresponding to the terminal that have been generated or configured by the second network element may include one or more context parameters of the terminal that have been generated or configured by the second network element, and/or one or more policies of the terminal that have been generated or configured by the second network element. In this case, the first network element may obtain the second-part parameter corresponding to the terminal from the at least part of the one or more core network elements as follows. The first network element obtain, from each core network element among the at least part of the one or more core network elements other than the second network element, part of parameters corresponding to the terminal that have been generated by that core network element, and takes the part of parameters corresponding to the terminal that have been generated by the second network element and the part of parameters corresponding to the terminal that have been generated by each core network element among the at least part of core network elements as the second-part parameter corresponding to the terminal.

Optionally, the first network element may obtain the second-part parameter corresponding to the terminal from at least part of the one or more core network elements, in the case that the request message sent by the target node is not received and the need to generate the first-part parameter corresponding to the terminal is triggered or determined according to other configurations.

With reference to the combination of the foregoing embodiments, the input information may include at least one of the request message, the static or global information, or the second-part parameter corresponding to the terminal. Exemplary descriptions of the possible content of the input information are provided below.

In an embodiment, the input information may only include the request message.

Optionally, the input information may include all content carried in the request message. For example, the request message carries an identifier of the terminal and scenario information, and the input information may include the identifier of the terminal and the scenario information carried in the request message. For another example, the request message may carry the identifier of the terminal, the scenario information, and user preference information, and the input information may include the identifier of the terminal, the scenario information, and the user preference information carried in the request message. All possible cases are not limited or enumerated herein.

Optionally, the input information may include part of the content carried in the request message. For example, the request message carries the identifier of the terminal and the scenario information, and the input information may include the identifier of the terminal or the scenario information carried in the request message. For another example, the request message may carry the identifier of the terminal, the scenario information, and the user preference information, and the input information may include at least one of the identifier of the terminal, the scenario information, or the user preference information carried in the request message. All possible cases are not limited or enumerated herein.

In an embodiment, the input information may only include static or global information. In this embodiment, regardless of whether the request message sent by the target node is received by the first network element, the processing for the first network element to generate the input information may include the following. The first network element obtains from at least part of the one or more core network elements and adds to the input information at least one of the following: the subscription information of the terminal, the PCC rule of the terminal, the network status information, the scenario information, or the user preference information.

In an embodiment, the input information includes the request message, and the static or global information.

Optionally, the request message may only carry the identifier of the terminal. The processing for the first network element to generate the input information may include that the first network element adds the identifier of the terminal and the static or global information to the input information.

Optionally, in addition to the identifier of the terminal, the request message may further carry the scenario information and/or the user preference information.

The static or global information may not include the scenario information and/or the user preference information, that is, the first network element may not need to obtain the scenario information and/or the user preference information from other network elements, and only need to obtain from at least part of the one or more core network elements at least one of the following: the subscription information of the terminal, the PCC rule of the terminal, or the network status information. The processing for the first network element to generate the input information may include the following. The first network element adds the identifier of the terminal carried in the request message to the input information, adds the scenario information and/or the user preference information carried in the request message to the input information, and adds to the input information at least one of the subscription information of the terminal, the PCC rule of the terminal, or the network status information that are obtained from the at least part of the one or more core network elements.

Alternatively, the first network element does not use the scenario information and/or the user preference information carried in the request message, and only uses the identifier of the terminal carried in the request message. Furthermore, the processing for the first network element to generate the input information may include the following. The first network element adds the identifier of the terminal carried in the request message to the input information, and adds to the input information at least one of the subscription information of the terminal, the PCC rule of the terminal, the network status information, the scenario information, or the user preference information that are obtained from the at least part of the one or more core network elements.

In an embodiment, the input information may only include the second-part parameter corresponding to the terminal. In the embodiment, the processing for the first network element to generate the input information may include the following. The first network element adds the second-part parameter corresponding to the terminal obtained from at least part of the one or more core network elements to the input information.

In an embodiment, the input information includes static or global information and the second-part parameter corresponding to the terminal. In this embodiment, the processing for the first network element to generate the input information may include the following. The first network element adds the static or global information and the second-part parameter corresponding to the terminal to the input information.

In an embodiment, the input information includes a request message and the second-part parameter corresponding to the terminal. In the embodiment, the processing for the first network element to generate the input information may include the following. The first network element adds the content carried in the request message and the second-part parameter corresponding to the terminal obtained from at least part of the one or more core network elements to the input information.

In an embodiment, the input information includes the request message, the static or global information, and the second-part parameter corresponding to the terminal.

Optionally, the request message may only carry the identifier of the terminal. The processing for the first network element to generate the input information may include the following. The first network element may add the identifier of the terminal, the static or global information, and the second-part parameter corresponding to the terminal to the input information.

Optionally, in addition to the identifier of the terminal, the request message may further carry the scenario information and/or the user preference information.

The static or global information may not include the scenario information and/or the user preference information. The processing for the first network element to generate the input information may include the following. The first network element adds the identifier of the terminal carried in the request message to the input information, adds the scenario information and/or the user preference information carried in the request message to the input information, adds the second-part parameter corresponding to the terminal to the input information, and adds at least one of the subscription information of the terminal, the PCC rule of the terminal, or the network status information, that are obtained from at least part of core network elements of the one or more core network elements, to the input information.

Alternatively, the first network element does not use the scenario information and/or the user preference information carried in the request message, and only uses the identifier of the terminal carried in the request message. Furthermore, the processing for the first network element to generate the input information may include the following. The first network element adds the identifier of the terminal, the static or global information, and the second-part parameter corresponding to the terminal to the input information.

In some possible implementations, the first network element may generate the first-part parameter corresponding to the terminal based on the input information as follows. The first network element generates the first-part parameter corresponding to the terminal based on the input information and a local configuration.

The local configuration may be information or configuration pre-configured or pre-saved locally in the first network element. Preferably, the local configuration may include a large model, where the large model may include one or more algorithms or may be composed of one or more algorithms. That is, the first network element may be a network element deployed with the large model. In some possible examples, the first network element may be referred to as an intelligent node or a large model node.

The first network element may generate the first-part parameter corresponding to the terminal based on the input information and the local configuration as follow. The first network element inputs the input information into the large model in the local configuration and obtains the first-part parameter corresponding to the terminal output by the large model. It should be understood that the large model may also be referred to as an artificial intelligence (AI) large model, an AI model, a model, etc. All possible names of the large model are not limited or enumerated herein, and any large model whose input may include the input information and output may include the first-part parameter corresponding to the terminal falls within the protection scope of the present embodiment.

It should also be understood that in addition to the aforementioned large model, the local configuration may further include at least one of other information, other parameters, other algorithms, etc., which are pre-configured or pre-saved locally in the first network element. The other information, other parameters, other algorithms, etc., pre-configured or pre-saved in the first network element are not limited or enumerated in the present embodiment.

Relevant descriptions of the training of the aforementioned large model are provided below. Similar to the current use of large models for training text data, there are correlation between various parameters in the context and/or policies of the terminal in the 3GPP system, which makes it possible to construct a word vector relationship graph for generating the context and/or policies of the terminal in different scenarios. Therefore, the generated context and/or policies of each terminal under the existing mechanism, in combination with corresponding data such as the scenario information and the subscription information, can be used as training text. By training the large model through a large amount of training text, a generalized model that can draw inferences from one instance can be achieved, thereby realizing the true on-demand usage of the large model to generate part or all of the context of the terminal/part or all of the policies of the terminal for different nodes of the 3GPP system in full scenarios.

Scenarios for generating the context and/or policies of the terminal by the large model to perform global configuration of the 3GPP system include the following possibilities. In a short-term scenario, the large model may be used for generating individual context parameter of the terminal and/or individual policy of the terminal, such as a currently pre-configured parameter or a parameter that need to be supplemented in the 3GPP. In a medium-term scenario, all of the context parameters of the terminal and/or all of the policies of the terminal may be generated by the large model. In a long-term scenario, new (or new types of) context parameters and/or policies may be created, set, or defined, thereby redefining functions such as mobility management (MM)/connection management (CM)/session management (SM) and changing the network elements and topology of the 3GPP system.

In conjunction with FIG. 5, an exemplary description of the training process of the large model is provided. The training text of the large model may include the following: scenario requirements (i.e., the scenario information in the foregoing embodiments), the subscription information of the terminal, and the context parameters of the terminal. In the training process exemplified at the left side of FIG. 5, the scenario requirements, the subscription information of the terminal, and part of the context parameters of the terminal in the training text may be used as input information for one training, including at least one of the following: the S-NSSAI, the DNN, a session type, etc. The “masked” at the left side of FIG. 5 refers to a parameter masked or removed from the context parameters of the terminal during training, and the “SSC mode” at the left side of FIG. 5 is a prediction result of the large model. The large model is trained with the training objective of whether the “SSC mode” output by the prediction result of the large model is the same as the parameter “SSC mode” masked or removed from the training text. In the training process exemplified at the right side of FIG. 5, the scenario requirements, the subscription information of the terminal, and part of the context parameters of the terminal in the training text may be used as input information for one training, including the S-NSSAI, the DNN (DNN=Internet), the Session type, a URSP (including DNN=IP multimedia subsystem (IMS)). The training objective exemplified at the right side of FIG. 5 is to train the large model to identify whether DNN=Internet is the same as URSP (DNN=IMS). If the output result is “no” as exemplified at the right side of FIG. 5, it indicates that the large model is trained successfully.

In conjunction with FIG. 6, an exemplary description of the relevant processing of the large model is provided. In the scenario illustrated in FIG. 6, the large model node (i.e., the first network element) may obtain the static or global information from a core network control plane network element (such as at least one of the following: the UDM, the PCF, the OAM network management, etc.), and/or obtain the second-part parameter corresponding to the terminal from a core network control plane network element (such as at least one of the following: the AMF, the SMF, the AF, etc.). The large model node may use the static or global information and/or the second-part parameter corresponding to the terminal as input information to obtain the first-part parameter corresponding to the terminal.

It should be understood that the above is only an exemplary description in which the input information includes the static or global information and/or the second-part parameter corresponding to the terminal. In actual processing, the content that may be included in the input information is the same as the content in the foregoing embodiments, for example, the input information may further include a registration request message from the terminal, etc., which will not be elaborated herein.

In some possible implementations, the first network element may send a response message to one or more nodes by the first network element as follows. The first network element sends a response message corresponding to each node to the each of one or more nodes. The response message corresponding to each node can carry at least one of the following: at least part of context parameters of the terminal used by the node among the first-part context parameter of the terminal or at least part of policies of the terminal corresponding to the node among the first-part policy of the terminal.

The one or more nodes include at least one of the following: the terminal, an access network device corresponding to the terminal, or one or more core network elements. After each of the one or more nodes receives the corresponding response message, the node may perform corresponding functions and behaviors according to the received at least part of the context parameters of the terminal and/or the at least part of the policies of the terminal. The subsequent behaviors or functions of each node are not limited in present embodiment.

In an embodiment, the response message corresponding to the terminal carries at least one of the following: at least part of context parameters used by the terminal among the first-part context parameter of the terminal or at least part of policies among the first-part policy of the terminal.

If the first network element supports the NAS protocol, the first network element may directly send to the terminal the response message corresponding to the terminal. If the first network element does not support the NAS protocol, the first network element may send the response message to the terminal through a third network element. The relevant description of the third network element is the same as the description in the foregoing embodiments, and will not be elaborated herein.

Optionally, the response message corresponding to the terminal may further carry a token of the terminal, and the token of the terminal is used for identifying the terminal and/or verifying the terminal when a relevant procedure is executed by the terminal.

Specifically, the token of the terminal may be content that needs to be carried when at least one message is sent by the terminal in other procedure. By carrying the token of the terminal when the at least one message is sent in the other procedure, the network element (such as any core network element) involved in the other procedure can identify or verify that the terminal is a terminal for which context parameters and/or UE policies have been allocated by the first network element, thus the locally saved context parameters of the terminal and/or UE policies can be extracted for subsequent processing. The other procedure may be any procedure specified in relevant protocols that needs to use the context parameters of the terminal and/or the UE policies. For example, the other procedure may include at least one of the following: a service request procedure, a location update procedure, a paging procedure, etc. The other procedure is not limited or enumerated in the present embodiment.

Optionally, if the terminal is a target node and the request message is sent to the first network element by the terminal, the request message may be at least one of the following: a registration request message, a registration update message, a PDU session establishment request message, or a PDU session modification request message. The response message corresponding to the terminal may be at least one of the following: a registration response message, a registration update response message, a PDU session establishment response message, or a PDU session modification response message. The response message may further carry at least one of the following: a registration result, a PDU session establishment/modification result, etc.

In an embodiment, a response message corresponding to the access network device corresponding to the terminal carries at least one of the following: at least part of context parameters of the terminal used by the access network device among the first-part context parameter of the terminal or at least part of policies of the terminal among the first-part policy of the terminal.

In an embodiment, a response message corresponding to each core network device among the one or more core network devices carries at least one of the following: at least part of context parameters of the terminal used by the core network device among the first-part context parameter of the terminal, at least part of policies of the terminal among the first-part policy of the terminal, or the first-part parameter corresponding to the terminal.

An exemplary description of the response message corresponding to each core network device among the one or more core network devices is provided below.

In an example, assuming that the 3GPP system follows the division of network elements in the 5G architecture, the one or more core network devices may include the AMF, the SMF, the PCF, the UDM, the UDR, the AF, the UPF, and the OAM.

In this example, the response message corresponding to the AMF may carry at least part of context parameters of the terminal used by the AMF among the first-part context parameter of the terminal. The response message corresponding to the SMF may carry at least part of context parameters of the terminal used by the SMF among the first-part context parameter of the terminal. The response message corresponding to the UPF may carry at least part of context parameters of the terminal used by the UPF among the first-part context parameter of the terminal. The response message corresponding to the AF may carry at least part of context parameters of the terminal used by the AF among the first-part context parameter of the terminal. The response message corresponding to the PCF may carry at least part of policies of the terminal among the first-part policy of the terminal. The response message corresponding to at least one of the UDM, the UDR, the PCF, or the OAM may carry the first-part parameter corresponding to the terminal (i.e., the specific content of the first-part context parameter of the terminal and/or the first-part policy of the terminal).

In this example, the response message corresponding to at least one of the UDM, the UDR, the PCF, or the OAM may further carry at least one of the following: whether the registration request from the terminal is received by the first network element, or for which node or nodes (i.e., the relevant number or identifier of each node among the one or more nodes) the corresponding at least part of context parameters of the terminal and/or the at least part of policies of the terminal is generated. The processing after receiving the response message by at least one of the UDM, the UDR, the PCF, or the OAM may include saving the first-part parameter corresponding to the terminal. Furthermore, the first-part parameter corresponding to the terminal saved by at least one of the UDM, the UDR, the PCF, or the OAM may be used for other relevant procedures, which are not limited herein.

It should be noted that if the one or more core network devices do not include the UPF, after the SMF receives the at least part of context parameters of the terminal used by the SMF among the first-part context parameter of the terminal, the SMF may further perform the following. The SMF generates at least part of context parameters of the terminal used by the UPF based on the at least part of context parameters of the terminal used by the SMF, and sends to the UPF the at least part of context parameters of the terminal used by the UPF.

In an example, assuming that the 3GPP system does not follow the division of network elements in the 5G architecture, the one or more core network devices may be divided on demand.

The response message corresponding to each of the one or more core network devices may carry at least one of the following: at least part of context parameters of the terminal used by the core network device among the first-part context parameter of the terminal, or at least part of policies of the terminal among the first-part policy of the terminal.

The at least part of context parameters of the terminal used by different core network devices may have different types. For example, the first-part context parameter of the terminal is divided into three types, namely a first type of at least part of the context parameters of the terminal, a second type of at least part of the context parameters of the terminal, and a third type of at least part of the context parameters of the terminal. Correspondingly, all core network devices associated with the first network element may be divided into 3 core network devices on demand by the first network element. A response message corresponding to core network device 1 may carry the first type of at least part of the context parameters of the terminal used by the core network device 1, a response message corresponding to core network device 2 may carry the second type of at least part of the context parameters of the terminal used by the core network device 2, and a response message corresponding to core network device 3 may carry the third type of at least part of the context parameters of the terminal used by the core network device 3.

In some embodiments, in the case that a response message corresponding to each core network device carries at least part of the first-part context parameter of the terminal used by the core network device and/or at least part of the first-part policy of the terminal corresponding to the core network device, the processing of the core network device may further include completing all the context parameters of the terminal used by the core network device and/or all the policies of the terminal.

The processing of completing all the context parameters of the terminal used by the core network device and/or all the policies of the terminal by the core network device may include at least one of the following. The core network device generates the remaining part of context parameters other than the part of context parameters of the terminal used by the core network device, and combines the part of context parameters of the terminal used by the core network device and the remaining part of context parameters to obtain all the context parameters of the terminal used by the core network device. The core network device generates the remaining part of policies other than the part of policies of the terminal, and combines the part of policies of the terminal and the remaining part of policies to obtain all the policies of the terminal. The core network device may use an existing mechanism to generate the remaining part of parameters other than the part of context parameters of the terminal used by core network device, which is not limited herein. The core network device may use an existing mechanism to generate the remaining part of policies other than the part of policies of the terminal, which is not limited herein.

Optionally, the first network element may not send the response message to the terminal. Rather, after all the context parameters of the terminal used by the core network device and/or all the policies of the terminal are obtained by the core network device, the core network device sends to the terminal all the context parameters of the terminal used by the terminal and/or all the policies of the terminal.

A message used by the core network device to send all the context parameters of the terminal used by the terminal and/or all the policies of the terminal to the terminal may be a message specified in a relevant protocol, which is not limited herein.

For example, assuming that the core network device is an AMF, the first network element generates the part of context parameters of the terminal used by the AMF, and send the part of context parameters of the terminal used by the AMF among the first-part context parameter of the terminal through the response message corresponding to the AMF. After the AMF generates the remaining part of context parameters by the AMF, the part of context parameters of the terminal used by the AMF and the remaining part of context parameters are combined to obtain all the context parameters of the terminal used by the AMF. The AMF generates all the context parameters used by the terminal, and sends to the terminal all the context parameters used by the terminal.

Optionally, the first network element may not send the response message to the access network device. Rather, after the core network device obtains all the context parameters of the terminal used by the core network device and/or all the policies of the terminal, the core network device sends to the access network device all the context parameters of the terminal and/or all the policies of the terminal used by the access network device. The message used by the core network device to send all the context parameters of the terminal and/or all the policies of the terminal used by the access network device to the access network device may be a message specified in a relevant protocol, which is not limited herein.

Optionally, the first network element may sends the response message to the terminal, where the response message carries part of the first-part context parameter of the terminal used by the terminal and/or part of the first-part policy of the terminal. Additionally or alternatively, the first network element may send the response message the access network device, where the response message carries part of the first-part context parameter of the terminal used by the access network device and/or part of the first-part policy of the terminal corresponding to the access network device.

In this case, after the core network device obtains all the context parameters of the terminal used by the core network device, the core network device may also send to the terminal all the context parameters used by the terminal and/or all the policies of the terminal, and additionally/alternatively, send to the access network device all the context parameters of the terminal and/or all the policies of the terminal used by the access network device. Correspondingly, in the case that the terminal receives all the context parameters of the terminal and/or all the policies of the terminal, the terminal may delete the part of context parameters of the terminal used by the terminal and/or the part of policies of the terminal and replace with/store all the context parameters of the terminal and/or all the policies of the terminal. Additionally or alternatively, in the case that the access network device receives all the context parameters of the terminal and/or all the policies of the terminal used by the access network device, the access network device deletes the part of context parameters of the terminal and/or the part of policies of the terminal used by the access network device, and replace with/store all the context parameters of the terminal and/or all the policies of the terminal used by the access network device.

The first network element (or referred to as the intelligent node or the large model node) involved in the foregoing embodiments can have a “God eye view” through the overlay AI architecture illustrated in FIG. 6, and directly interact with used nodes, thereby generating the most suitable context parameters of the terminal and/or policies of the terminal for each node to achieve the optimal system performance.

The introduction of the first network element (or referred to as the intelligent node or the large model node) will change the design of existing architecture and procedures, realizing intelligent substitution and intelligent optimization. Specific considerations include the following.

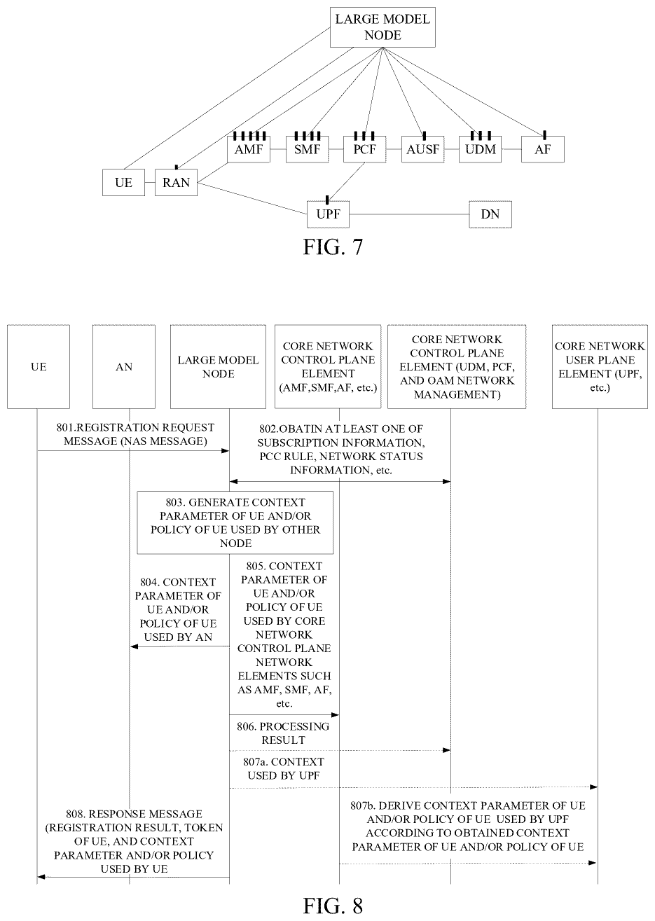

First, a service defined by the SBA mechanism in the 5G architecture can be used for connecting with the large model node to support interaction with the large model. In this way, the SBI can be reused to define new functional services, and the existing procedure can still be used in the initial stage for adding the first network element at the core network side. For example, as illustrated in FIG. 7, a “large model node” is added based on the 5G architecture illustrated in FIG. 2. The large model node is provided with newly-defined interfaces with core network elements (such as the AMF, the SMF, the PCF, the AUSF, the UDM, the AF, etc., illustrated in FIG. 7), and the large model node is also provided with newly-defined interfaces with the RAN and the UE (i.e., the terminal).

Second, the NAS protocol is used in the interaction between the terminal and the first network element. For example, the terminal and the first network element may directly interact using the NAS protocol, or the AMF may serve as a forwarding node between the terminal and the first network element.

Third, the first network element can replace various network elements in the 5G system architecture to generate the context and/or policies of the terminal in different procedures. For example, in the initial registration procedure and the PDU session establishment procedure, interactions between various core network elements are no longer required, and the context and/or policies of the terminal are uniformly generated and configured by the first network element.

Fourth, part of 5G network elements such as the NSSF and network slice access control function (NSACF) can be replaced by the first network element (such as functions of determining allowed NSSAI, determining configured NSSAI, etc.).

Fifth, 3GPP procedures that do not involve the update (or generation) of the context and/or policies of the terminal are still executed using existing procedures, such as location update, service request, paging, etc.

Sixth, the behaviors and functions of each core network element are executed based on the context and/or policies of the terminal configured by the first network element, and the behaviors and functions of each core network element are still completed by the core network element itself.

With reference to FIG. 8, the communication method provided by the embodiment of the present disclosure is exemplarily described, with the first network element taken as a large model node, the terminal denoted as UE, and the access network device denoted as access network (AN). The method specifically includes the following.

Step 801, a registration request node (i.e., the target node in the foregoing embodiments, and the UE in this example) sends a request message to the large model node. The request message is an NAS message and may carry information such as an identifier of the UE, scenario content (i.e., the scenario information in the foregoing embodiments), and user preference settings (i.e., the user preference information).

Step 802, the large model node obtain at least one of subscription information, a PCC rule, network status information, etc. by interaction with part of network functions (NF) (such as core network control plane network elements (UDM, PCF, OAM network management, etc.) illustrated in FIG. 7).

Step 803, the large model node generates context parameters of the UE and/or policies of the UE used by other nodes based on at least one of the request message of the UE and the obtained subscription information, PCC policy, network status information, etc. The number of the other nodes may be one or more, i.e., the one or more nodes in the foregoing embodiments, and the one or more nodes may include at least one of the UE, the AN, the SMF, the UPF, the PCF, the OAM, etc.

It should be noted that the context parameters of the UE and/or policies of the UE used by other nodes may be context parameters of the UE and/or policies of the UE used for a certain (or some) node(s). For example, the context parameters of the UE may include access and mobility (AM) context and session management (SM) context. Alternatively, the context parameters of the UE and/or policies of the UE used by any other node may be part of the context parameters of the UE and/or part of the policies of the UE used by the node, and the remaining part of the context parameters of the UE and/or the remaining part of the policies of the UE may still be generated according to existing mechanisms or locally by the node itself.

Step 804, the large model node sends to the AN the context parameters of the UE and/or policies of the UE used by AN.

Step 805, the large model node sends the context parameters of the UE and/or policies of the UE used by the core network control plane network element such as the AMF, the SMF, the AF, etc. to the corresponding nodes respectively.

Step 806, the large model node sends the processing result (such as whether the registration request of the UE is accepted, for which node(s) the context parameters of the UE and/or policies of the UE is generated, and the specific content of the context parameters of the UE and/or policies of the UE) to at least one of the UDM, the PCF, or the OAM network management for storage.

The large model node may execute step 807a or step 807b. Step 807a, if the large model node directly derives the context parameters of the UE and/or policies of the UE for the UPF by, the derived context parameters and/or policies are directly sent to the UPF. Step 807b, if other core network control plane network element (such as the SMF illustrated in FIG. 7) derives, according to the obtained context parameters of the UE and/or policies of the UE, the context parameters of the UE and/or policies of the UE (or related configuration parameters) used by the core network user plane network element (such as the UPF), the derived context parameters and/or policies are sent to the UPF by the SMF.

Step 808, the UE receives an NAS response message. The response message may include the registration result, the token of the UE, and the context parameters and/or policies (such as URSP policy, etc.) used by the UE. The response message may be directly sent to the UE by the large model node through the NAS message. The token of the UE may be used in subsequent interactions with other core network elements (such as executing a service request procedure and a location update procedure).

It should be noted that the execution order of the foregoing step 804 to step 808 may be arbitrary, that is, as long as the relevant processing content in the foregoing step 804 to step 808 is included in the actual processing, it falls within the protection scope of the present embodiment, and the execution order of step 804 to step 808 is not limited.

Each network element illustrated in FIG. 8 executes subsequent corresponding functions and behaviors according to the context parameters of the UE and/or policies of the UE configured by the large model node, which is not limited herein.

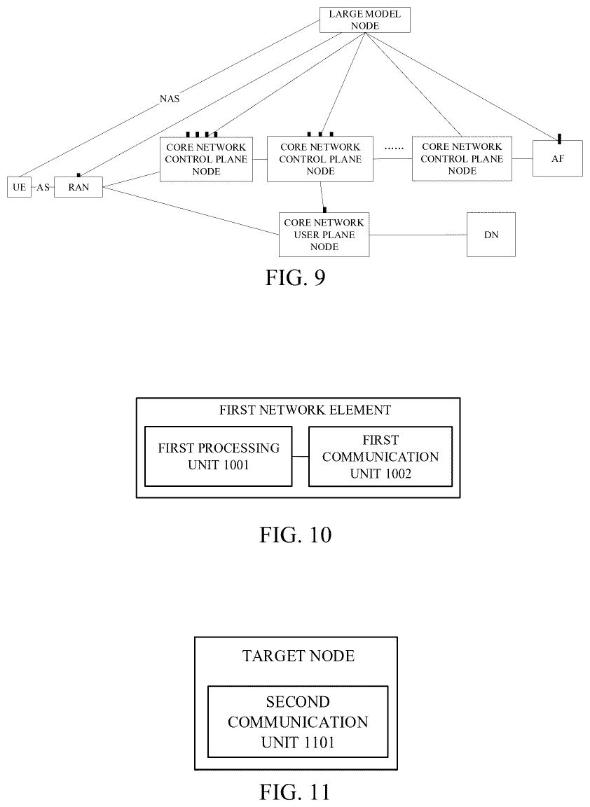

With reference to FIG. 9, another architecture applicable to the communication method provided by the embodiment of the present disclosure is exemplarily described, with the first network element taken as the large model node, the terminal denoted as the UE, and the access network device denoted as the AN. In the scenario illustrated in FIG. 9, the one or more core network nodes (or network elements) may be divided according to actual needs. When the 3GPP system not only provides communication (connection) service but also provides computation, data, and model-related services, more new context parameters need to be defined to describe functions related to connection, computation, data, and model (four elements of quality of AI service (QoAIS)) that each node needs to provide. In this scenario, the division of nodes (or network elements) of the network designed based on the 5G architecture may no longer be applicable. The first network element (the intelligent node or the large model node) may flexibly allocate the context and/or policies corresponding to the four elements of the QoAIS to each node (such as one or more core network control plane nodes (or network elements) and core network user plane nodes (or network elements) illustrated in FIG. 9), that is, content of the context and/or policies included in each node (or network element) can be flexibly allocated. At least one of the one or more core network control plane nodes (or network elements) illustrated in FIG. 8 can still interact with the AF, and the core network user plane nodes (or network elements) can still interact with the DN. In addition, in the scenario illustrated in FIG. 9, the UE and the large model node can interact through the NAS message, and the UE and the RAN can interact through an access stratum (AS) message.

In the scenario illustrated in FIG. 9, an procedure of allocating context parameters and/or policies of the UE is similar to the procedure in the corresponding example illustrated in FIG. 7. The main differences are that the context allocated by the large model node includes the four elements of the QoAIS, and the core network control plane nodes and core network user plane nodes are divided on demand, so no repeated explanation will be provided herein.

By adopting the foregoing solution, the first network element can generates at least part of the context and/or at least part of the policies of the terminal according to the input information, and send the response message carrying at least part of content of the at least part of the context and/or at least part of the policies of the terminal to each of the one or more nodes. In this way, the first network element can more flexibly allocate the at least part of the context and/or at least part of the policy of the terminal to the corresponding node. In addition, since the first network element can interact with multiple nodes to obtain relevant parameters, the relevant parameters that the first network element can obtain are no longer limited, thus ensuring that the finally generated context and/or policies of the terminal are more suitable for each node.

FIG. 10 is a schematic diagram of the composition structure of a first network element according to an embodiment of the present disclosure. The first network element includes a first processing unit 1001 and a first communication unit 1002. The first processing unit 1001 is configured to generate a first-part parameter corresponding to a terminal based on input information. The first-part parameter corresponding to the terminal includes at least one of a first-part context parameter of the terminal or a first-part policy of the terminal. The first communication unit 1002 is configured to send a response message to one or more nodes. The response message carries at least part of the first-part parameter corresponding to the terminal, and the one or more nodes includes at least one of the following: the terminal, an access network device corresponding to the terminal, or one or more core network elements.

The input information includes a request message.

The first communication unit is further configured to receive the request message sent by a target node. The target node is one of the terminal and a second network element. The second network element is one of the one or more core network elements.

The request message carries at least one of an identifier of the terminal, scenario information, or user preference information.

The input information includes at least one of subscription information of the terminal, a PCC rule of the terminal, network status information, the scenario information, and the user preference information.

The first communication unit is further configured to obtain, from at least part of core network elements of the one or more core network elements, at least one of: the subscription information of the terminal, the PCC rule of the terminal, the network status information, the scenario information, or the user preference information.

The input information includes a second-part parameter corresponding to the terminal. The second-part parameter corresponding to the terminal is at least partially different from the first-part parameter corresponding to the terminal.

The first communication unit is further configured to obtain the second-part parameter corresponding to the terminal from at least part of core network elements of the one or more core network elements.

The second-part parameter corresponding to the terminal includes at least one of a second-part context parameter of the terminal or a second-part policy of the terminal.

The policy includes at least one of a UE policy, a PDR policy, or a data flow binding policy.

The one or more core network elements includes at least one of the following: one or more core network control plane network elements and one or more core network user plane network elements.

The one or more core network control plane network elements includes at least one of the following: a network element responsible for access and/or mobility management and a network element responsible for session management.

FIG. 11 is a schematic diagram of the composition structure of a target node according to an embodiment of the present disclosure. The target node includes a second communication unit 1101. The second communication unit 1101 is configured to receive a response message sent by a first network element. The response message carries at least part of a first-part parameter corresponding to a terminal, and the first-part parameter corresponding to the terminal includes at least one of a first-part context parameter of the terminal or a first-part policy of the terminal.

The second communication unit is further configured to send a request message to the first network element. The request message is used for the first network element to generate the first-part parameter corresponding to the terminal.

The request message carries at least one of the following: an identifier of the terminal, scenario information, or user preference information.

The policy includes at least one of the following: a UE policy, a PDR policy, or a data flow binding policy.

The target node is one of the terminal and a second network element. The second network element is one of one or more core network elements.

The one or more core network elements includes at least one of the following: one or more core network control plane network elements or one or more core network user plane network elements.

The one or more core network control plane network elements includes at least one of the following: a network element responsible for access and/or mobility management, or a network element responsible for session management.

The device of the embodiment of the disclosure can implement the corresponding functions of the device in the foregoing method embodiments. For the processes, functions, implementation manners, and beneficial effects corresponding to each module (sub-module, unit, component, etc.) in the first network element, reference can be made to the corresponding descriptions in the above method embodiments, and details are not repeated herein. It should be noted that the functions described for each module (sub-module, unit, component, etc.) in the first network element of the embodiment of the disclosure can be implemented by different modules (sub-modules, units, components, etc.) or by the same module (sub-module, unit, component, etc.).

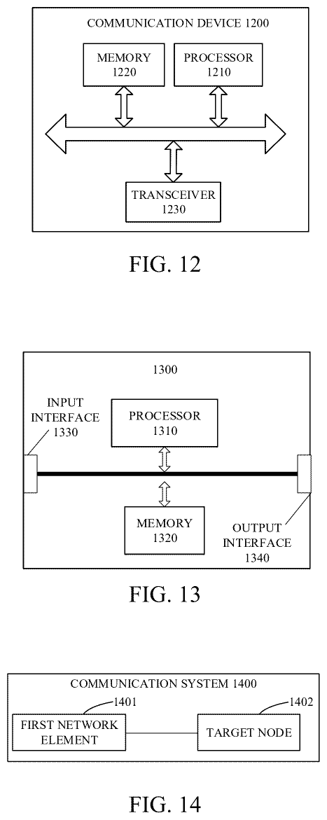

FIG. 12 is a schematic block diagram of a communication device 1200 according to an embodiment of the disclosure. The communication device 1200 includes a processor 1210, and the processor 1210 can invoke and execute computer programs from a memory to cause the communication device 1200 to implement the method in the embodiments of the disclosure.

In an implementation, the communication device 1200 may further include a memory 1220. The processor 1210 can invoke and execute the computer program from the memory 1220 to cause the communication device 1200 to implement the method in the embodiments of the disclosure. The memory 1220 may be an independent component separate from the processor 1210, or may be integrated into the processor 1210.

In an implementation, the communication device 1200 may further include a transceiver 1230, and the processor 1210 can control the transceiver 1230 to communicate with other devices. Specifically, the communication device 1200 can transmit information or data to other device, or receive information or data transmitted by other devices. The transceiver 1230 may include a transmitter and a receiver. The transceiver 1230 may further include antennas, and the number of antennas may be one or more.

In an implementation, the communication device 1200 may be a first network element or a target node in the embodiments of the disclosure, and the communication device 1200 can implement the corresponding processes performed by the first network element or the target node in each method of the embodiments of the disclosure, which will not be repeated herein for the sake of brevity.

FIG. 13 is a schematic structural diagram of a chip 1300 according to embodiments of the disclosure. The chip 1300 includes a processor 1310, and the processor 1310 can invoke and execute a computer program from a memory to implement the method in the embodiments of the disclosure.

In an implementation, the chip 1300 may further include a memory 1320. The processor 1310 can invoke and execute the computer program from the memory 1320 to implement the method performed by a first network element or a target node in the embodiments of the disclosure. The memory 1320 may be an independent component separate from the processor 1310, or may be integrated into the processor 1310.

In an implementation, the chip 1300 may further include an input interface 1330. The processor 1310 can control the interface 1330 to communicate with other devices or chips. Specifically, the input interface 1330 can obtain information or data transmitted by other devices or chips.

In an implementation, the chip 1300 may further include an output interface 1340. The processor 1310 can control the interface 1340 to communicate with other devices or chips. Specifically, the output interface 1340 can output information or data to other devices or chips.

In an implementation, the chip can be applied to the first network element or the target node in the embodiments of the disclosure, and the chip can implement the corresponding processes performed by the first network element or the target node in each method of the embodiments of the disclosure, which will not be repeated herein for the sake of brevity.

It should be understood that the chip in embodiments of the disclosure may also be referred to as a system-on-chip (SOC).

The processor described above may be a general-purpose processor, a digital signal processor (DSP), a field programmable gate array (FPGA), an application specific integrated circuit (ASIC), or other programmable logic devices, transistor logic devices, discrete hardware components, etc. The general purpose processor mentioned above may be a microprocessor, or the processor may be any conventional processor or the like.

The memory mentioned above may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory can be a random access memory (RAM).

It should be understood that, the memory above is intended for illustration rather than limitation. For example, the memory in embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), etc. In other words, the memory in embodiments of the disclosure is intended to include, but is not limited to, these and any other suitable types of memory.

FIG. 14 illustrates a schematic block diagram of a communication system 1400 according to an embodiment of the disclosure. The communication system 1500 includes a first network element 1401 and a target node 1402. The first network element 1401 can be configured to implement corresponding functions implemented by the first network element in the foregoing methods, and the target node 1402 is configured to implement corresponding functions implemented by the target node in the foregoing methods, which will not be repeated herein for the sake of brevity.

All or some of the above embodiments can be implemented through software, hardware, firmware, or any other combination thereof. When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), a semiconductor medium (such as a solid state disk (SSD)), etc.

It should also be understood that, in various method embodiments of the disclosure, the magnitude of a sequence number of each of the foregoing processes does not mean an execution order, and an execution order of each process should be determined according to a function and an internal logic of the process, which shall not constitute any limitation to an implementation process of embodiments of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be described in detail again herein.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A communication method, comprising:
generating, by a first network element, a first-part parameter corresponding to a terminal based on input information, wherein the first-part parameter corresponding to the terminal comprises at least one of a first-part context parameter of the terminal or a first-part policy of the terminal; and
sending, by the first network element, a response message to one or more nodes, wherein the response message carries at least part of the first-part parameter corresponding to the terminal, and the one or more nodes comprises at least one of: the terminal, an access network device corresponding to the terminal, or one or more core network elements.

2. A network element, comprising:
a memory configured to store a computer program;
a transceiver configured to communicate with other devices; and
a processor configured to invoke and execute the computer program stored in the memory, to cause the network element to:
generate a first-part parameter corresponding to a terminal based on input information, wherein the first-part parameter corresponding to the terminal comprises at least one of a first-part context parameter of the terminal or a first-part policy of the terminal; and
send a response message to one or more nodes, wherein the response message carries at least part of the first-part parameter corresponding to the terminal, and the one or more nodes comprises at least one of: the terminal, an access network device corresponding to the terminal, or one or more core network elements.

3. The network element of claim 2, wherein the input information comprises a request message.

4. The network element of claim 3, wherein the network element is a first network element, and the processor is further configured to execute the computer program stored in the memory to cause the network element to:
receive the request message sent by a target node, wherein the target node is one of the terminal and a second network element, and the second network element is one of the one or more core network elements.

5. The network element of claim 3, wherein the request message carries at least one of: an identifier of the terminal, scenario information, or user preference information.

6. The network element of claim 2, wherein the input information comprises at least one of: subscription information of the terminal, a policy and charging control (PCC) rule of the terminal, network status information, scenario information, or user preference information.

7. The network element of claim 6, wherein the processor is further configured to execute the computer program stored in the memory to cause the network element to:
obtain, from at least part of core network elements of the one or more core network elements, at least one of: the subscription information of the terminal, the PCC rule of the terminal, the network status information, the scenario information, or the user preference information.

8. The network element of claim 2, wherein the input information comprises a second-part parameter corresponding to the terminal, wherein the second-part parameter corresponding to the terminal is at least partially different from the first-part parameter corresponding to the terminal.

9. The network element of claim 8, wherein the processor is further configured to execute the computer program stored in the memory to cause the network element to:
obtain the second-part parameter corresponding to the terminal from at least part of core network elements of the one or more core network elements.

10. The network element of claim 8, wherein the second-part parameter corresponding to the terminal comprises at least one of a second-part context parameter of the terminal or a second-part policy of the terminal.

11. The network element of claim 2, wherein the policy comprises at least one of: a user equipment (UE) policy, a packet detection rule (PDR) policy, or a data flow binding policy.

12. The network element of claim 2, wherein the one or more core network elements comprises at least one of: one or more core network control plane network elements, or one or more core network user plane network elements.

13. The network element of claim 12, wherein the one or more core network control plane network elements comprises at least one of: a network element responsible for access and/or mobility management, or a network element responsible for session management.

14. A communication node, comprising:
a memory configured to store a computer program;
a transceiver configured to communicate with other devices; and
a processor configured to invoke and execute the computer program stored in the memory, to cause the communication node to:
receive a response message sent by a first network element, wherein the response message carries at least part of a first-part parameter corresponding to a terminal, and the first-part parameter corresponding to the terminal comprises at least one of a first-part context parameter of the terminal or a first-part policy of the terminal.

15. The communication node of claim 14, wherein the processor is further configured to execute the computer program stored in the memory to cause the communication node to:
send a request message to the first network element, wherein the request message is used for the first network element to generate the first-part parameter corresponding to the terminal.

16. The communication node of claim 15, wherein the request message carries at least one of: an identifier of the terminal, scenario information, or user preference information.

17. The communication node of claim 14, wherein the policy comprises at least one of: a user equipment (UE) policy, a packet detection rule (PDR) policy, or a data flow binding policy.

18. The communication node of claim 14, wherein the communication node is one of the terminal and a second network element, and the second network element is one of one or more core network elements.

19. The communication node of claim 18, wherein the one or more core network elements comprises at least one of: one or more core network control plane network elements, or one or more core network user plane network elements.

20. The communication node of claim 19, wherein the one or more core network control plane network elements comprises at least one of: a network element responsible for access and/or mobility management, or a network element responsible for session management.
